(19) United States
(12) Patent Application Publication
(10) Pub. No.: US 2025/0322225 A1
(43) Pub. Date: Oct. 16, 2025

(54) DISTRIBUTED PROCESSING ON A NEURAL NETWORK CHIP

(71) Applicant: Chromatic Inc., New York, NY (US)

(72) Inventor: Andrew Casper, Inver Grove Heights, MN (US)

(21) Appl. No.: 19/176,949

(22) Filed: Apr. 11, 2025

Related U.S. Application Data
(60) Provisional application No. 63/633,176, filed on Apr. 12, 2024.

(51) Int. Cl. G06N 3/063; G06F 17/16

(52) U.S. Cl. CPC G06N 3/063; G06F 17/16

(57) ABSTRACT

A neural network chip may include a plurality of tiles including a first tile and a second tile. The first tile may be configured to generate first data at least in part by performing first multiply-accumulate operations. The second tile may be configured to generate second data at least in part by performing second multiply-accumulate operations. The second tile may be configured to transmit a control signal to the first tile when the second data has been generated. The first tile may be configured to transmit the first data to the second tile when the control signal has been received and the first data has been generated. The second tile may be configured to combine the second data generated by the second tile with the first data received from the first tile to produce combined first data and second data.

### FIELD

The present disclosure relates to neural network chips. Some aspects relate to distributed processing on neural network chips.

### BACKGROUND

Recently, neural network chips have been developed. Further description of neural network chips may be found in U.S. Pat. No. 11,886,974, entitled “Neural Network Chip for Ear-Worn Device,” and issued Jan. 30, 2024, which is incorporated by reference herein in its entirety. One application of neural network chips is in ear-worn devices, such as hearing aids, cochlear implants, and earphones. Their performance can be improved by utilizing neural networks, for example, to denoise audio signals. Further description of such neural networks may be found in U.S. Pat. No. 11,812,225, titled METHOD, APPARATUS AND SYSTEM FOR NEURAL NETWORK HEARING AID, and issued on Nov. 7, 2023, which is incorporated by reference herein in its entirety.

### SUMMARY

To attain tolerable latencies when implementing a neural network on a device, the device may need to be capable of performing billions of operations per second. To address power issues with such demanding requirements, the neural network may be implemented on a neural network chip in the device. This arrangement may be particularly pertinent where the device is, for example, an ear-worn device or another device that may have only a limited available power supply.

In some embodiments, processing a layer of a neural network may include computing matrix-vector operations including multiplication of an input activation vector by a matrix of neural network weights (i.e., a matrix-vector multiplication). As described in U.S. Pat. No. 11,886,974, a neural network chip may include multiple tiles (which may be identical) each configured to perform sub-operations, and the neural network chip may be configured to combine results of these sub-operations to generate a final result for a matrix-vector operation.

In some scenarios, when performing sub-operations among multiple tiles whose results are to be combined, tiles may finish generating their data at different times. The inventor has developed technology for efficient, distributed processing of matrix-vector operations across tiles of a neural network chip. Consider, as an example, a row of tiles in which each tile, i.e., each of a first tile in the row and subsequent tiles in that row, is configured to perform sub-operations, and the results of the sub-operations are to be combined. Each tile may finish generating its own data at different times. In some embodiments, each subsequent tile may generate its own data, and upon completion send a control signal to the preceding tile in the row. In this example, the preceding tile is the tile to the left of the subsequent tile. With the exception of the last tile in the row, each tile may send its data to the next tile, in this example, the tile to its right, when two conditions are met: the tile has finished generating its own data, and the tile has received the control signal from the next tile (i.e., indicating that it is ready to receive data). The next tile may receive the data, combine the received data with its own generated data, and then send the combined data to the next tile, e.g. the tile to its right, when those same two conditions are met. Thus, control signals may be transmitted from each subsequent tile to its preceding tile, and then data may flow from tile to next tile, from one end of the row to the other, being combined along the way. The combined data may ultimately form a portion of a final result. It should be appreciated that this example is non-limiting, and the directions in which the control signals and data are sent may be different, and the tiles may be distributed along a column or some other orientation. Generally, a first tile may generate first data, a second tile may generate second data, and the second tile may transmit a control signal to the first tile when the second data has been generated. The first tile may transmit its first data to the second tile when two conditions are satisfied: when the control signal has been received and the first data has been generated. The second tile may then combine its second data with the first data received from the first tile to produce combined first data and second data.

The aspects and embodiments described above, as well as additional aspects and embodiments, are described further below. These aspects and/or embodiments may be used individually, all together, or in any combination of two or more, as the disclosure is not limited in this respect.

### BRIEF DESCRIPTION OF THE DRAWINGS

The following detailed description sets out illustrative embodiments with reference to the drawings, in which:

FIG. 1 illustrates a tile in a neural network chip, in accordance with certain embodiments described herein;

FIG. 2 illustrates a bias circuit in a neural network chip, in accordance with certain embodiments described herein;

FIG. 3 illustrates a neural network chip, in accordance with certain embodiments described herein;

FIG. 4 illustrates an ear-worn device, in accordance with certain embodiments described herein.

FIG. 5 illustrates a hearing aid, in accordance with certain embodiments described herein.

### DETAILED DESCRIPTION

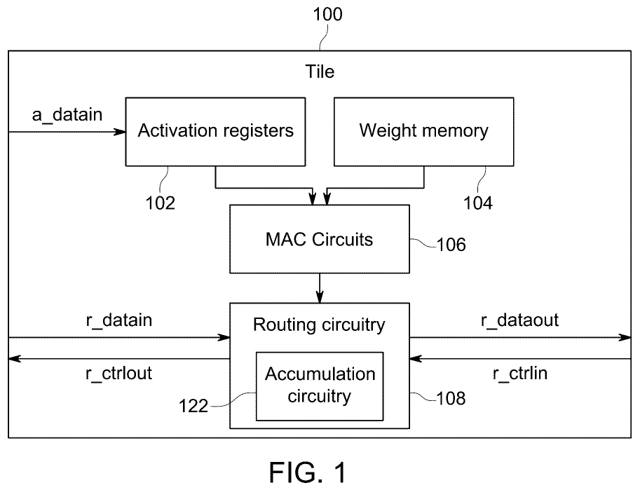

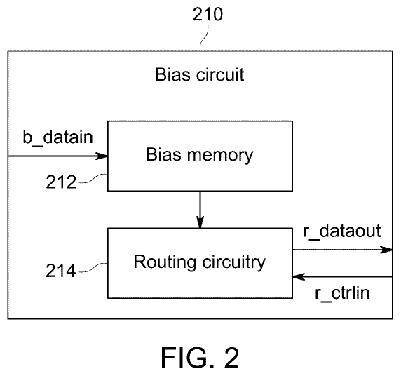

In some embodiments, a neural network chip may include a plurality of tiles (described in FIG. 1), which may be substantially identical, and bias circuits (described in FIG. 2), which may also be substantially identical. FIG. 1 illustrates a tile 100 in a neural network chip, in accordance with certain embodiments described herein. The tile 100 may be one of a plurality of substantially identical tiles in the neural network chip. The tile 100 includes activation registers 102, weight memory 104, multiplier-accumulator (MAC) circuits 106, and routing circuitry 108. The routing circuitry 108 includes accumulation circuitry 122.

As will be described further below, the MAC circuits 106 may be configured to perform multiply-accumulate (MAC) operations using input activation elements and neural network weights. The activation registers 102 may be configured to store input activation elements. The activation registers 102 may be configured to receive the input activation elements at the input a_datain. The weight memory 104 may be configured to store neural network weights. As the weight memory 104 is disposed in the tile 100 itself, it may not be necessary to retrieve neural network weights from memory external to the tile 100, which may reduce power consumption. Each MAC circuit 106 may be configured to receive an input activation element from the activation registers 102, receive a neural network weight from the weight memory 104, and perform a MAC operation using the input activation element and the neural network weight (i.e., multiply the input activation element by the neural network weight and accumulate the result with a stored running sum of already-performed multiplication results). The routing circuitry 108 may be configured to route and combine results among tiles 100 and other elements of the neural network chip, as will be described further below. The routing circuitry 108 may be configured to output a control signal at the output r_ctrolout, receive a control signal at the input r_ctrlin, receive data at the input r_datain, and output data at the output r_dataout. The accumulation circuitry 122 may be configured to accumulate (i.e., sum) data received by the tile 100 with data computed by the tile 100.

FIG. 2 illustrates a bias circuit 210 in a neural network chip, in accordance with certain embodiments described herein. The bias circuit 210 includes bias memory 212 and routing circuitry 214. The bias memory 212 may be configured to store bias elements. The bias memory 212 may be configured to receive the bias elements at the input b_datain. The routing circuitry 214 may be configured to route bias elements to another tile 100. As will be described further below, the routing circuitry 214 may be configured to receive a control signal at the input r_ctrlin and output data at the output r_dataout.

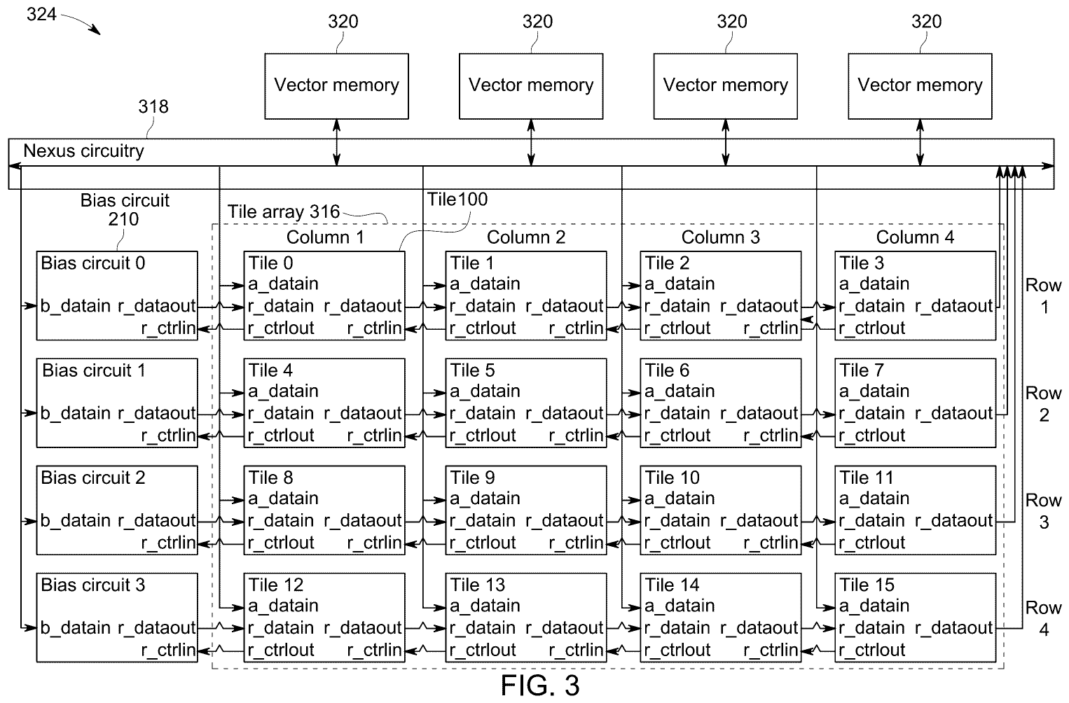

FIG. 3 illustrates a neural network chip 324, in accordance with certain embodiments described herein. The neural network chip 324 includes a tile array 316, bias circuits 210, nexus circuitry 318, and vector memories 320. The example tile array 316 of FIG. 3 includes 16 tiles 100 in 4 rows and 4 columns (although other sizes and dimensions may be used). In the example of FIG. 3, the vector memories 320 are coupled to the nexus circuitry 318, and the nexus circuitry 318 is coupled to the a_datain inputs of the tiles 100 and the b_datain inputs of the bias circuits 210. The r_ctrlout output of each tile 100 in the rightmost three columns is coupled to the r_ctrlin input of the tile 100 to its left. The r_ctrlout output of each tile 100 in the leftmost column is coupled to the r_ctrlin input of the bias circuit 210 to its left. The r_dataout output of each tile 100 in the leftmost three columns is coupled to the r_datain input of the tile 100 to its right. The r_dataout output of each bias circuit 210 is coupled to the r_datain input of the tile 100 to its right. The r_dataout output of each tile 100 in the rightmost column is coupled to the nexus circuitry 318.

In some embodiments, processing a layer of a neural network may include computing one or more matrix-vector operations including multiplication of an input activation vector by a matrix of neural network weights (i.e., a matrix-vector multiplication). The matrix-vector operation may be written as y=Ax+b, where A is a matrix including neural network weights, x is an input activation vector, b is a bias element vector, and y is a result vector. (In some embodiments, bias elements may not be used.) An input activation vector x may be derived from an input audio signal. For example, the input activation vector x for the first layer of a neural network may be the result of processing a digitized input signal (e.g., a digitized version of an audio input signal). Each result vector y (i.e., the result of processing an input activation vector x using the neural network weights in A) may be, or may be used to form, the input (i.e., the input activation vector x) to a subsequent layer of the neural network. The operation y=Ax+b may be written in expanded notation as follows:

$$Ax + b = [ \begin{matrix}a 1 , 1 & a 1 , 2 & … & a 1 , n \\ a 2 , 1 & a 2 , 2 & … & a 2 , n \\ ⋮ & ⋮ & ⋮ & ⋮ \\ am , 1 & am , 2 & … & am , 2\end{matrix} ] [ \begin{matrix}x 1 \\ x 2 \\ ⋮ \\ xn\end{matrix} ] + [ \begin{matrix}b 1 \\ b 2 \\ ⋮ \\ bm\end{matrix} ] = [ \begin{matrix}a 1 , 1 \times x 1 + a 1 , 2 \times x 2 + … + a 1 , n \times xn + b 1 \\ a 2 , 1 \times x 1 + a 2 , 2 \times x 2 + … + a 2 , n \times xn + b 2 \\ … \\ am , 1 \times x 1 + am , 2 \times x 2 + … + am , n \times xn + bm\end{matrix} ]$$

The inventor has recognized that a matrix-vector multiplication such as Ax may be broken into multiple vector-vector multiplications. If A[k,:] denotes the kth row of the matrix A, and A has N rows, then the matrix-vector multiplication Ax may be broken up into A[0,:]x; A[1,:]x; . . . ; A[N-1,:]x, where each multiplication A[k,:]x is a vector-vector multiplication. Each of the vector-vector multiplications may be broken into element-by- element multiplications summed together over multiple clock cycles. If x[k] denotes the kth element of the vector x, and x has M elements, then on the first clock cycle, the following elements of the output vector may be computed: x[0]*A[0,0]; x[0]*A[1,0]; . . . ; x[0]*A[N-1,0]. Individual MAC circuits 106 may be configured to perform each of these multiplications in parallel, and it should be appreciated that one or more, or all, of the MAC circuits 106 in a tile 100 may be configured to use the same input activation element on a single clock cycle. For example, on the first clock cycle, multiple MAC circuits 106 may all be using the same input activation element x[0] in their multiplications. On the second clock cycle, the following elements of the output vector may be computed: x[1]*A[0,1]; x[1]*A[1,1]; . . . ; x[1]*A[N-1,1]. MAC circuits 106 may be configured to sum (i.e., accumulate) these results with results of the computation from the previous clock cycle to produce x[0]*A[0,0]+x[1]*A[0,1]; x[0]*A[1,0]+x[1]*A[1,1]; . . . ; x[0]*A[N-1,0]+x[1]*A[N-1,1]. For example, the MAC circuit 106 that computed x[0]*A[0,0] on the first clock cycle may compute x[1]*A[0,1] on the second clock cycle and sum those results together. The final clock cycle may result in x[0]*A[0,0]+ . . . +x[M]*A[0,M-1]; x[0]*A[1,0]+ . . . +x[M]*A[1,M-1]; . . . ; x[0]*A[N-1,0]+ . . . +x[M]*A[N-1,M-1]=A[0,:]x +A[1,:]x+ . . . +A[N-1,:]x=Ax=y.

In the example of FIG. 3, the array includes 16 tiles 100 in a tile array 316 of 4 rows and 4 columns, with each row including a bias circuit. Consider y=Ax+b, where as an example, x is a 256-element input activation vector, A is a 256×256-element neural network weight matrix, and b is a 256-element bias element vector. In other words, referring to the expanded notation above, m=256 and n=256. Tiles 100 in column 1 may each receive the elements x1-x64 of the input activation vector, tiles 100 in column 2 may each receive x65-x128, tiles 100 in column 3 may each receive x129-x192, and tiles 100 in column 4 may each receive x193-x256. Tile 0 may receive the first 64 rows and the first 64 columns of the matrix A (i.e., a1,1-a,64,64), tile 1 may receive the first 64 rows and the second 64 columns of the matrix A (i.e., a1,65-a64,128), tile 5 may receive the second 64 rows the second 64 columns of the matrix A (i.e., a65,65-a128,128), etc. The bias circuit 0 may receive biases b1-b64, the bias circuit 1 may receive biases b65-b128, the bias circuit 2 may receive biases b129-b192, and the bias circuit 4 may receive biases b193-b256.

Consider that each tile 100 includes 64 MAC circuits 106 configured to perform MAC operations. On each clock cycle, each MAC circuit 106 in each tile 100 may multiply one of the input activation elements x with one of the neural network weights from the matrix A and accumulate that product with any previous results. For example, on a first clock cycle, Tile 0 may use its 64 MAC circuits 106 to calculate the following products: a1,1*x1; a2,1*x1; . . . ; a64,1*x1 (each MAC circuit 106 computing a different product). It can be appreciated that each MAC circuit 106 may use the same element of the input activation vector (in this case, x1) on a single clock cycle. On a second clock cycle, Tile 0 may use its 64 MAC circuits 106 to calculate the following products: a1,2*x2; a2,2*x2; . . . ; a64,2*x2. On this clock cycle, Tile 0 may accumulate these products with the products from the previous clock cycle to produce a1,1*x1+a1,2*x2; a2,1*x1+a2,2*x2; . . . ; a64,1*x1+a64,2*x2. After 64 clock cycles, Tile 0 may have calculated the following: a1,1*x1+a1,2 *x2+ . . . +a1,64*x64; a2,1*x1+a2,2*x2+ . . . +a2,64*x64; . . . ; a64,1*x1+a64,2*x2+ . . . +a64,64*x64. Tile 0 may locally store the following weights for use in these calculations: a1,1; a1,2; . . . ; a1,64; a2,1; a2,2; . . . a64,64. In a similar vein, after 64 clock cycles, Tile 1 may have calculated the following: a1,65*x65+a1,66*x66+ . . . +a1,128*x128; a2,65*x65+a2,66*x66+ . . . +a2,128*x128; . . . ; a64,65*x65+a64,66*x66 + . . . +a64,128*x128. The results from Tiles 0 and 1 may be summed together along with the results from tiles 2 and 3 and bias elements from bias circuit 0. The result from row 1 may thus be a1,1*x1+a1,2*x2+ . . . +a1,256*x256+b1; a2,1*x1+a2,2*x2+ . . . +a2,256*x256+b2; . . . ; a64,1*x1+a64,2*x2+ . . . +a64,256*x256+b64. These may be the first 64 elements of the output vector y. It should be appreciated that while results from tiles 100 within a row may need to be summed to generate y, results from tiles 100 in one row may not need to be summed with results from tiles 100 in any other row in order to generate y.

The following is a description of how the neural network chip 324 may implement the above scheme for distributed processing of matrix-vector operations across tiles 100 of the neural network chip 324. In operation, the vector memory 320 may be configured to transfer input activation elements and bias elements to the nexus circuitry 318, and the nexus circuitry 318 may be configured to transmit the input activation elements and bias elements to the appropriate tiles 100 and bias circuits 210. Neural network weights may already be stored in the weight memory 104 of the tile 100. Each tile 100 may be configured to generate data at least in part by performing multiply-accumulate operations using input activation elements from its activation registers 102 and neural network weights from its weight memory 104. As referred to herein, data generated by a tile 100 may refer to the results of the tile 100's own multiply-accumulate operations or may refer to the sum of the results of the tile 100's own multiply-accumulate operations with data from other tiles 100 and/or with bias elements from bias circuits 210. As described above, in some embodiments, results of multiply-accumulate (MAC) operations from tiles 100 within a row may be summed to generate elements of the output vector y.

Generating data by a tile 100 may take multiple clock cycles. The routing circuitry 108 of a first tile 100 may be configured to transmit a control signal to the routing circuitry 108 of a second tile 100 when the first tile's data has been generated (e.g., when the first tile 100 has generated the results of its MAC operations, or when the first tile 100 has generated the results of its MAC operations and summed that data with data received from another tile 100 or bias circuit 210). The routing circuitry 108 of the second tile 100 may be configured to transmit its data to the routing circuitry 108 of the first tile 100 when the control signal has been received and the second tile's data has been generated (e.g., when the second tile 100 has generated the results of its MAC operations, or when the second tile 100 has generated the results of its MAC operations and summed that data with data received from another tile 100 or bias circuit 210). The accumulation circuitry 122 in the first tile 100's routing circuitry may be configured to combine (i.e., accumulate) the data received from the second tile 100 with the data generated by the first tile 100. In some embodiments, tiles 100 that transmit data from one to another may be in the same row of the tile array 316. In some embodiments, tiles 100 that transmit data from one to another may be in the same column of the tile array 316. In some embodiments, tiles 100 that transmit data from one to another may be adjacent to each other.

In some cases, the combined data may be transmitted to a third tile 100, and the accumulation circuitry 122 of the third tile 100 may be configured to combine the transmitted data with data generated by the third tile 100. In some cases, the combined data from the accumulation circuitry 122 of the third tile 100 may be transmitted to a fourth tile 100, etc. Generally, data may be transmitted from tile 100 to tile 100 multiple times within a group of tiles 100, being accumulated with each transmission. In some embodiments, the group of tiles 100 may be in a row of the tile array 316. In some embodiments, the group of tiles 100 may be in a column of the tile array 316.

For example, referring the neural network chip 324, each tile 100 in the three rightmost columns may be configured to transmit a control signal from its r_ctrlout output to the r_ctrlin input of the tile 100 to its left indicating that it has completed its computations and is ready to receive data from the adjacent tile 100 for summing. In some embodiments, each tile 100 in the leftmost column may be configured to transmit a control signal from its r_ctrolout output to the r_ctrlin input of the adjacent bias circuit 210 to its left indicating that it has completed its computations and is ready to receive a bias element from the adjacent bias circuit 210 for summing. When a tile 100 in the leftmost three columns receives the control signal, it may transmit its results (i.e., the results of its MAC circuits 106's MAC operations) from its r_dataout output to the r_datain input of the adjacent tile 100 to its right when those results are ready (e.g., when it has generated the results of its MAC operations, or when it has generated the results of its MAC operations and summed that data with data received from another tile 100 or bias circuit 210). Those results may already be ready, in which case the tile 100 may be configured to transmit the results immediately. If the results are not yet ready, the tile 100 may be configured to wait to transmit the results when they are ready. Because a bias circuit 210 may not have any computations to perform, when a bias circuit 210 receives the control signal, it may transmit its bias elements immediately from its r_dataout output to the r_datain input of the adjacent tile 100 to its right. When a tile 100 receives data at its r_datain input from an adjacent tile 100, the tile 100 may be configured to sum its own data with the received data using the accumulation circuitry 122.

As described above, data may be transmitted from tile 100 to tile 100 multiple times within a group of tiles, being accumulated with each transmission. The last tile 100 to receive data in the group may be configured to transmit the combined data to one of the vector memories 320. For example, consider a first tile 100 that generates first data, a second tile 100 that generates second data, a third tile 100 that generates third data, and a fourth tile 100 that generates fourth data. The first tile 100 may be configured to send the first data to the second tile 100, and the second tile 100 may be configured to combine the first data and the second data. If the second tile 100 is the last tile 100 to receive data in a group, the second tile 100 may be configured to transmit the combined first data and second data to a first vector memory 320. The third tile 100 may be configured to send the third data to the fourth tile 100, and the fourth tile 100 may be configured to combine the third data and the fourth data. If the fourth tile 100 is the last tile 100 to receive data in a group, the fourth tile 100 may be configured to transmit the combined third data and fourth data to a second vector memory 320. When this description refers to a tile 100 transmitting data to a vector memory 320, in some embodiments the tile 100 may be configured to transmit the data to the nexus circuitry 318, and the nexus circuitry 318 may be configured to transmit the data to the vector memory 320. In some embodiments, the tile 100 may be configured to transmit the data to the vector memory 320 without nexus circuitry 318 in between.

For example, with reference to FIG. 3, when data has been computed and accumulated in a tile 100 in the rightmost column, the tile 100 may be configured to transmit the data to the nexus circuitry 318, and the nexus circuitry 318 may be configured to transmit the data to one of the vector memories 320. In some embodiments, the nexus circuitry 318 may be configured to transmit data from the rightmost column of a specific row to a specific vector memory 320. For example, data from the first row from the top of the tile array 316 may be transmitted to the first vector memory 320 from the left, data from the second row from the top of the tile array 316 may be transmitted to the second vector memory 320 from the left, data from the third row from the top of the tile array 316 may be transmitted to the third vector memory 320 from the left, and data from the fourth row from the top of the tile array 316 may be transmitted to the fourth vector memory 320 from the left.

In some embodiments, in one mode, a first tile 100 may be configured to transmit its first data to a second tile 100, and the second tile 100 may be configured to combine its second data with the first data and transmit the combined first and second data to vector memory 320 (directly or through the nexus circuitry 318). However, the first tile 100 may also be configurable in a different mode to transmit its first data to the vector memory 320. In such embodiments, if the first tile 100 transmits its data to the nexus circuitry 318, the nexus circuitry 318 may be configurable to transmit the data to the vector memory 320.

In some embodiments, even tiles 100 not at the end of a row or column may be configured to transmit data to the vector memory 320, optionally via nexus circuitry 318. For example, with reference to FIG. 3, in some embodiments, even tiles 100 not in the rightmost column may be configured in a mode in which they may transmit data to the nexus circuitry 318 and from there to the vector memory 320. Such a mode may be used, for example, if different groups of tiles 100 are being used to simultaneously perform different matrix-vector multiplications, such that the data from every tile 100 in a row may not need to be summed prior to being transmitted to the nexus circuitry 318 and from there to the vector memory 320.

It should be appreciated that, as described above, based on the scheme for distributed processing of matrix-vector operations across tiles 100 of the neural network chip 324, data from different rows may not need to be combined. Generally, data from different groups of tiles 100 may not need to be combined. For example, consider a first tile 100 that generates first data, a second tile 100 that generates second data, a third tile 100 that generates third data, and a fourth tile 100 that generates fourth data. The first tile 100 may be configured to send the first data to the second tile 100, and the second tile 100 may be configured to combine the first data and the second data. The third tile 100 may be configured to send the third data to the fourth tile 100, and the fourth tile 100 may be configured to combine the third data and the fourth data. In some embodiments, the neural network chip 324 may not be configured to combine the third data with the first data or the second data, nor to combine the fourth data with the first data or the second data. In some embodiments, the first tile 100 and the second tile 426 may be in the same row of the tile array 316, the third tile 100 and the fourth tile 100 may be in the same row of the tile array 316, and the two rows may be different. In some embodiments, the first tile 100 and the second tile 100 may be in the same column of the tile array 316, the third tile 100 and the fourth tile 100 may be in the same column of the tile array 316, and the two columns may be different. This description will focus on the former option.

Thus, in some embodiments, tiles 100 in one row may not be configured to transmit data to tiles 100 in another row. Following the above example, the third tile 100 may not be configured to transmit data to the first tile 100 or the second tile 100, the fourth tile 100 may not be configured to transmit data to the first tile 100 or the second tile 100, the first tile 100 may not be configured to transmit data to the third tile 100 or the fourth tile 100, and the second tile 100 may not be configured to transmit data to the third tile 100 or the fourth tile 100. In some embodiments, the neural network chip 324 may lack independent connections (i.e., connections just between two tiles 100) between tiles 100 in different rows (or, in some embodiments, different columns). Thus, following the above example, the third tile 100 may lack an independent connection to the first tile 100 or the second tile 100, and the fourth tile 100 may lack an independent connection to the first tile 100 or the second tile 100.

Certain elements of the result vector y, generated based (at least in part) on the matrix-vector multiplication Ax, may be based on the combined first data and second data. Other elements of the result vector y may be based on the combined third data and fourth data. For example, consider that first neural network weights used by the first tile 100 and second neural network weights used by the second tile 100 come from rows 1 to M of the neural network weight matrix A, and third neural network weights used by the third tile and fourth neural network weights used by the fourth tile come from rows M+1 to 2M of the neural network weight matrix A. Then, the elements of the result vector y based on the combined first data and second data may be in rows 1 to M of Y, and the elements of the result vector y based on the combined third data and fourth data may be in rows M+1 to 2M of y.

Returning to the above example of a 256×256 neural network weight matrix A, this size neural network matrix (or smaller) may be conveniently processed by 64 MAC circuits 106 in each of 16 tiles 100 in a single run through the tile array 316 according to the distributed processing scheme described above. For a larger neural network weight matrix A than 256×256, but the same numbers of MAC circuits 106 and tiles 100, partial results from multiple runs through the tile array 316 may be accumulated in the vector memory 320.

In some embodiments, the interfaces between tiles 100 that transmit data to each other may be credited interfaces. In such interfaces, a first tile 100 may give “credit” to a second tile 100 to send data, and once the second tile 100 receives that “credit,” the second tile 100 may be free to send data to the first tile 100. The “credit” may be a pulse on a credit line (e.g., the inputs and outputs r_ctrolout and r_ctrlin).

In some embodiments, data transmitted from a first tile 100 to a second tile 100 may include a plurality of words of data, the routing circuitry 108 of the first tile 100 may be configured to transmit N words of the plurality of words of data to the routing circuitry 108 of the second tile 100 on a single clock cycle, and N may be greater than 1. In some embodiments, the second tile 100's accumulation circuitry 122 may include N accumulator circuits. For example, with reference to FIG. 3, a tile 100 may be configured to transmit multiple words of data on a single clock cycle from its r_dataout output to the r_datain input of the adjacent tile 100. In this context, a word of data may be the result of MAC operations performed by one MAC circuit 106. For example, a tile 100 may be configured to transmit two words of data at a time. If there are 64 MAC circuits 106 per tile 100, then it may take 32 clock cycles to transfer all data from one tile 100 to another. In some embodiments, there may be the same number of instances of accumulation circuitry 122 in the routing circuitry 108 of each tile 100 as the number of words transmitted on a single clock cycle. Thus, if two words are transmitted on a single clock cycle from tile 100 to tile 100, there may be two accumulation circuits 122 in each tile 100. In some embodiments, a tile 100 may execute further MAC operations for a matrix-vector multiplication at the same time as that tile 100 is transmitting data to routing circuitry 108 of another tile 100. For example, performing processing for an LSTM (long short-term memory) neural network may include performing four matrix-vector multiplications per layer of the neural network. When tiles 100 have finished performing the MAC operations for a matrix-vector multiplication for one layer, during clock cycles when data from those operations is being transmitted from tile 100 to tile 100, tiles 100 may perform MAC operations for a matrix-vector multiplication for another layer simultaneously with that transmission.

In some embodiments, tiles 100 may be switched to an operational mode in which they immediately transmit data to an adjacent tile 100, without waiting for a control signal from the adjacent tile 100. For example, if bias elements are not used, then tiles 100 in the leftmost column may be placed in such a mode.

As described above, the neural network chips and the methods described above may be implemented in an ear-worn device, such as a hearing aid, cochlear implant, or earphone. However, the neural network chips and the methods described above may also be used in other applications (e.g., general audio processing).

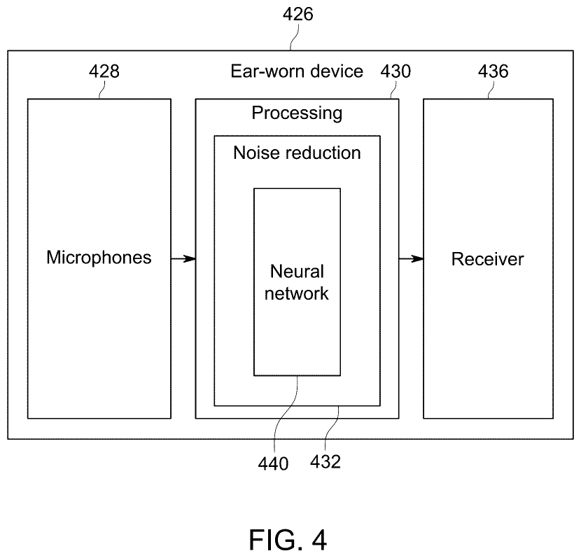

FIG. 4 illustrates an ear-worn device 426, in accordance with certain embodiments described herein. The ear-worn device 426 may be, for example, a hearing aid, a cochlear implant, or an earphone. The ear-worn device 426 includes microphones 428, processing circuitry 430, and a receiver 436. The processing circuitry 430 includes noise reduction circuitry 432. The noise reduction circuitry 432 includes neural network circuitry 440 configured to implement a neural network (or, more generally, one or more neural network layers).

The one or more microphones 428 may include one, two, or more than two (e.g., 3, 4, or more) microphones. For example, the one or more microphones 428 may include two microphones, a front microphone that is closer to the front of the wearer of the ear-worn device 426 and a back microphone that is closer to the back of the wearer of the ear-worn device 426. As another example, the one or more microphones 428 may include more than two microphones in an array. Microphones in an array may be linked via wireless communication (e.g., the microphones may be disposed on two different ear-worn devices configured for binaural communication). The one or more microphones 428 may be configured to receive sound signals and to generate audio signals from the sound signals.

The processing circuitry 430 may be configured to process the audio signals from the microphones 428. The processing circuitry 430 may be configured to perform some or all of input calibration, anti-feedback processing, wind reduction, short-time Fourier transformation (STFT), wide dynamic range compression (WDRC), inverse STFT, and output calibration. The processing circuitry 430 may be additionally configured to perform noise reduction using the neural network circuitry 440. The neural network circuitry 440 may be configured to implement a neural network trained to perform noise reduction, which may include background noise reduction and/or spatial focusing (e.g., for focusing on speech from certain directions and not others). The neural network circuitry 440 may include some or all of the circuitry illustrated in FIG. 3. Thus, in some embodiments, some or all of the neural network circuitry 440 may be implement a neural network chip (e.g., the neural network chip 324).

The receiver 436 may be configured to play back the output of the processing circuitry 104 as sound into the ear of the user. It should be appreciated that the ear-worn device 426 and/or any of its components may include more elements than illustrated, and these elements may be coupled upstream, downstream, or between any of the elements illustrated in FIG. 4.

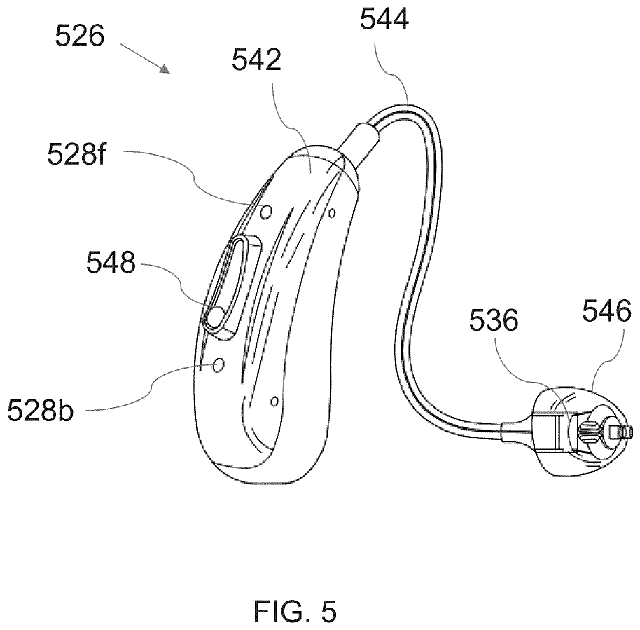

FIG. 5 illustrates a hearing aid 526, in accordance with certain embodiments described herein. The hearing aid 526 may be an example of the ear-worn device 426. In this particular example, the hearing aid 526 is a receiver-in-canal (RIC) (also referred to as a receiver-in-the-ear (RITE)) type of hearing aid. However, any other type of hearing aid (e.g., behind-the-ear, in-the-ear, in-the-canal, completely-in-canal, open fit, etc.) may be provided. The hearing aid 526 includes a body 542, a receiver wire 544, a receiver 536 (which may correspond to the receiver 436), and a dome 546. The body 542 is coupled to the receiver wire 544 and the receiver wire 544 is coupled to the receiver 536. The dome 546 is placed over the receiver 536. The body 542 includes a front microphone 528f, a back microphone 528b, and a user input device 548. (The front microphone 528f and the back microphone 528b may correspond to the one or more microphones 428). The body 542 additionally includes circuitry (e.g., any of the circuitry described above, aside from the receiver 536) not illustrated in FIG. 5. When the hearing aid 526 is worn, the front microphone 528f may be closer to the front of the wearer and the back microphone 528b may be closer to the back of the wearer. The front microphone 528f and the back microphone 528b may be configured to receive sound signals and generate audio signals based on the sound signals. The user input device 548 may be configured to control certain functions of the hearing aid 526, such as switching modes. The receiver wire 544 may be configured to transmit audio signals from the body 542 to the receiver 536. The receiver 536 may be configured to receive audio signals (i.e., those audio signals generated by the body 542 and transmitted by the receiver wire 544) and generate sound signals based on the audio signals. The dome 546 may be configured to fit tightly inside the wearer's ear and direct the sound signal produced by the receiver 536 into the ear canal of the wearer.

In some embodiments, the length of the body 542 may be equal to 2 cm, equal to 5 cm, or between 2 and 5 cm in length. In some embodiments, the weight of the hearing aid 526 may be less than 4.5 grams. In some embodiments, the spacing between the microphones may be equal to 5 mm, equal to 12 mm, or between 5 and 12 mm. In some embodiments, the body 542 may include a battery (not visible in FIG. 5), such as a lithium ion rechargeable coin cell battery.

This disclosure includes, at least, the following examples.

Example 1 is directed to a neural network chip, comprising: a plurality of tiles comprising a first tile and a second tile, wherein: the first tile is configured to generate first data at least in part by performing first multiply-accumulate operations; the second tile is configured to generate second data at least in part by performing second multiply-accumulate operations; the second tile is configured to transmit a control signal to the first tile when the second data has been generated; the first tile is configured to transmit the first data to the second tile when the control signal has been received and the first data has been generated; and the second tile is configured to combine the second data generated by the second tile with the first data received from the first tile to produce combined first data and second data.

Example 2 is directed to the neural network chip of example 1, wherein the plurality of tiles are arranged in a tile array, and the first tile and the second tile are in a same column or a same row of the tile array.

Example 3 is directed to the neural network chip of any of examples 1-2, further comprising a third tile configured to generate third data and a fourth tile configured to generate fourth data, and wherein: the fourth tile is configured to combine the third and fourth data to produce combined third data and fourth data.

Example 4 is directed to the neural network chip of example 3, wherein the neural network chip is not configured to combine the third data with the first data or second data, nor to combine the fourth data with the first data or second data.

Example 5 is directed to the neural network chip of any of examples 3-4, wherein: the plurality of tiles are arranged in a tile array; the first tile and the second tile are in a first row, the third tile and the fourth tile are in a second row, and the first row and the second row are different; or the first tile and the second tile are in a first column, the third tile and the fourth tile are in a second column, and the first column and the second column are different.

Example 6 is directed to the neural network chip of any of examples 3-5, wherein: the neural network chip is configured to generate a result vector based at least in part on a matrix-vector multiplication; first elements of the result vector are based on the combined first data and second data; and second elements of the result vector are based on the combined third data and fourth data.

Example 7 is directed to the neural network chip of example 6, wherein: the first neural network weights and the second neural network weights are from rows 1 to M of a neural network weight matrix; third neural network weights used by the third tile and fourth neural network weights used by the fourth tile are from rows M+1 to 2M of the neural network weight matrix; the first elements of the result vector are in rows 1 to M of the result vector; and the second elements of the result vector are in rows M+1 to 2M of the result vector.

Example 8 is directed to the neural network chip of any of examples 3-7, wherein: the neural network chip further comprises a first vector memory and a second vector memory; the second tile is configured to transmit the combined first data and second data to the first vector memory; and the fourth tile is configured to transmit the combined third data and fourth data to the second vector memory.

Example 9 is directed to the neural network chip of any of examples 3-8, wherein the first tile is configurable to transmit the first data to the first vector memory.

Example 10 is directed to the neural network chip of any of examples 3-9, wherein: the neural network chip further comprises a first vector memory, a second vector memory, and nexus circuitry; the second tile is configured to transmit the combined first data and second data to the nexus circuitry; the fourth tile is configured to transmit the combined third data and fourth data to the nexus circuitry; and the nexus circuitry is configured to transmit the combined first data and second data to the first vector memory and to transmit the combined third data and fourth data to the second vector memory.

Example 11 is directed to the neural network chip of example 10, wherein the first tile is configurable to transmit the first data to the nexus circuitry, and the nexus circuitry is configurable to transmit the first data to the first vector memory.

Example 12 is directed to the neural network chip of any of examples 3-11, wherein: the third tile is configured to not transmit data to the first tile or the second tile.

Example 13 is directed to the neural network chip of any of examples 3-12, wherein the third tile lacks an independent connection to the first tile and lacks an independent connection to the second tile.

Example 14 is directed to the neural network chip of any of examples 1-14, wherein: the neural network chip is configured to generate a result vector based on a matrix-vector multiplication; and first elements of the result vector are based on the combined first data and second data.

Example 15 is directed to the neural network chip of example 14, wherein: the first neural network weights and the second neural network weights are from rows 1 to M of a neural network weight matrix; and the first elements of the result vector are in rows 1 to M of the result vector.

Example 16 is directed to the neural network chip of any of examples 1-15, wherein an interface between the first tile and the second tile comprises a credited interface.

Example 17 is directed to the neural network chip of any of examples 1-16, wherein the first tile and the second tile are physically adjacent to each other.

Example 18 is directed to the neural network chip of any of examples 1-17, wherein: the first tile comprises first activation registers, first weight memory, first multiplier-accumulator (MAC) circuits, and first routing circuitry comprising first accumulation circuitry; the second tile comprises second activation registers, second weight memory, second MAC circuits, and second routing circuitry comprising second accumulation circuitry; the first tile is configured to generate the first data at least in part by performing the first multiply-accumulate operations using first input activation elements from the first activation registers and first neural network weights from the first weight memory; the second tile is configured to generate the second data at least in part by performing the second multiply-accumulate operations using second input activation elements from the second activation registers and second neural network weights from the second weight memory; the second routing circuitry is configured to transmit the control signal to the first routing circuitry when the second data has been generated; the first routing circuitry is configured to transmit the first data to the second routing circuitry when the control signal has been received and the first data has been generated; and the second accumulation circuitry in the second routing circuitry is configured to combine the second data generated by the second tile with the first data received from the first routing circuitry of the first tile to produce the combined first data and second data.

Example 19 is directed to the neural network chip of example 18, wherein more than one of the first MAC circuits are configured to use a same input activation element on a single clock cycle.

Example 20 is directed to the neural network chip of any of examples 18-19, wherein: the tile array further comprises a third tile; the third tile comprises third activation registers, third weight memory, third multiplier-accumulator (MAC) circuits, and third routing circuitry comprising third accumulation circuitry; the third tile is configured to generate third data at least in part by performing multiply-accumulate operations using third input activation elements from the third activation registers and third neural network weights from the third weight memory; the third routing circuitry is configured to transmit a control signal to the second routing circuitry when the third data has been generated; the second routing circuitry is configured to transmit the combined first data and second data to the third routing circuitry; and the third accumulation circuitry in the third routing circuitry is configured to combine the third data generated by the third tile with the combined first data and second data received from the second routing circuitry of the second tile.

Example 21 is directed to the neural network chip of any of examples 18-21, wherein the first data comprises a plurality of words of data, the first routing circuitry of the first tile is configured to transmit N words of the plurality of words of data to the second routing circuitry of the second tile on a single clock cycle, and N is greater than 1.

Example 22 is directed to the neural network chip of example 21, wherein the second accumulation circuitry in the second routing circuitry comprises N accumulator circuits.

Example 23 is directed to the neural network chip of any of examples 18-22, wherein: the neural network chip further comprises a bias circuit; the first routing circuitry of the first tile is configured to transmit a second control signal to the bias circuit when the first data has been generated; and the bias circuit is configured to transmit one or more bias elements to the first routing circuitry of the first tile when the second control signal is received.

Example 24 is directed to the neural network chip of any of examples 1-23, wherein the first tile is configured to perform further multiply-accumulate operations while the first data is being transmitted to the second tile.

Example 25 is directed to an ear-worn device comprising the neural network chip of any of examples 1-24.

Example 26 is directed to the ear-worn device of example 25, wherein the ear-worn device is a hearing aid, a cochlear implant, or an earphone.

Having described several embodiments of the techniques in detail, various modifications and improvements will readily occur to those skilled in the art. Such modifications and improvements are intended to be within the spirit and scope of the invention. Accordingly, the foregoing description is by way of example only, and is not intended as limiting. For example, any components described above may comprise hardware, software or a combination of hardware and software.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be objects of this disclosure. Accordingly, the foregoing description and drawings are by way of example only.

1. A neural network chip, comprising:
a plurality of tiles comprising a first tile and a second tile, wherein:
the first tile is configured to generate first data at least in part by performing first multiply-accumulate operations;
the second tile is configured to generate second data at least in part by performing second multiply-accumulate operations;
the second tile is configured to transmit a control signal to the first tile when the second data has been generated;
the first tile is configured to transmit the first data to the second tile when the control signal has been received and the first data has been generated; and
the second tile is configured to combine the second data generated by the second tile with the first data received from the first tile to produce combined first data and second data.

2. The neural network chip of claim 1, wherein the plurality of tiles are arranged in a tile array, and the first tile and the second tile are in a same column or a same row of the tile array.

3. The neural network chip of claim 1, further comprising a third tile configured to generate third data and a fourth tile configured to generate fourth data, and wherein:
the fourth tile is configured to combine the third and fourth data to produce combined third data and fourth data.

4. The neural network chip of claim 3, wherein the neural network chip is not configured to combine the third data with the first data or second data, nor to combine the fourth data with the first data or second data.

5. The neural network chip of claim 3, wherein:
the plurality of tiles are arranged in a tile array;
the first tile and the second tile are in a first row, the third tile and the fourth tile are in a second row, and the first row and the second row are different; or
the first tile and the second tile are in a first column, the third tile and the fourth tile are in a second column, and the first column and the second column are different.

6. The neural network chip of claim 3, wherein:
the neural network chip is configured to generate a result vector based at least in part on a matrix-vector multiplication;
first elements of the result vector are based on the combined first data and second data; and
second elements of the result vector are based on the combined third data and fourth data.

7. The neural network chip of claim 6, wherein:
the first neural network weights and the second neural network weights are from rows 1 to M of a neural network weight matrix;
third neural network weights used by the third tile and fourth neural network weights used by the fourth tile are from rows M+1 to 2M of the neural network weight matrix;
the first elements of the result vector are in rows 1 to M of the result vector; and
the second elements of the result vector are in rows M+1 to 2M of the result vector.

8. The neural network chip of claim 3, wherein;
the neural network chip further comprises a first vector memory and a second vector memory;
the second tile is configured to transmit the combined first data and second data to the first vector memory; and
the fourth tile is configured to transmit the combined third data and fourth data to the second vector memory.

9. The neural network chip of claim 3, wherein the first tile is configurable to transmit the first data to the first vector memory.

10. The neural network chip of claim 3, wherein:
the neural network chip further comprises a first vector memory, a second vector memory, and nexus circuitry;
the second tile is configured to transmit the combined first data and second data to the nexus circuitry;
the fourth tile is configured to transmit the combined third data and fourth data to the nexus circuitry; and
the nexus circuitry is configured to transmit the combined first data and second data to the first vector memory and to transmit the combined third data and fourth data to the second vector memory.

11. The neural network chip of claim 10, wherein the first tile is configurable to transmit the first data to the nexus circuitry, and the nexus circuitry is configurable to transmit the first data to the first vector memory.

12. The neural network chip of claim 3, wherein:
the third tile is configured to not transmit data to the first tile or the second tile.

13. The neural network chip of claim 3, wherein the third tile lacks an independent connection to the first tile and lacks an independent connection to the second tile.

14. The neural network chip of claim 1, wherein:
the neural network chip is configured to generate a result vector based on a matrix-vector multiplication; and
first elements of the result vector are based on the combined first data and second data.

15. The neural network chip of claim 14, wherein:
the first neural network weights and the second neural network weights are from rows 1 to M of a neural network weight matrix; and
the first elements of the result vector are in rows 1 to M of the result vector.

16. The neural network chip of claim 1, wherein an interface between the first tile and the second tile comprises a credited interface.

17. The neural network chip of claim 1, wherein the first tile and the second tile are physically adjacent to each other.

18. The neural network chip of claim 1, wherein:
the first tile comprises first activation registers, first weight memory, first multiplier-accumulator (MAC) circuits, and first routing circuitry comprising first accumulation circuitry;
the second tile comprises second activation registers, second weight memory, second MAC circuits, and second routing circuitry comprising second accumulation circuitry;
the first tile is configured to generate the first data at least in part by performing the first multiply-accumulate operations using first input activation elements from the first activation registers and first neural network weights from the first weight memory;
the second tile is configured to generate the second data at least in part by performing the second multiply-accumulate operations using second input activation elements from the second activation registers and second neural network weights from the second weight memory;
the second routing circuitry is configured to transmit the control signal to the first routing circuitry when the second data has been generated;
the first routing circuitry is configured to transmit the first data to the second routing circuitry when the control signal has been received and the first data has been generated; and
the second accumulation circuitry in the second routing circuitry is configured to combine the second data generated by the second tile with the first data received from the first routing circuitry of the first tile to produce the combined first data and second data.

19. The neural network chip of claim 18, wherein more than one of the first MAC circuits are configured to use a same input activation element on a single clock cycle.

20. The neural network chip of claim 18, wherein:
the tile array further comprises a third tile;
the third tile comprises third activation registers, third weight memory, third multiplier-accumulator (MAC) circuits, and third routing circuitry comprising third accumulation circuitry;
the third tile is configured to generate third data at least in part by performing multiply-accumulate operations using third input activation elements from the third activation registers and third neural network weights from the third weight memory;
the third routing circuitry is configured to transmit a control signal to the second routing circuitry when the third data has been generated;
the second routing circuitry is configured to transmit the combined first data and second data to the third routing circuitry; and
the third accumulation circuitry in the third routing circuitry is configured to combine the third data generated by the third tile with the combined first data and second data received from the second routing circuitry of the second tile.

21. The neural network chip of claim 18, wherein the first data comprises a plurality of words of data, the first routing circuitry of the first tile is configured to transmit N words of the plurality of words of data to the second routing circuitry of the second tile on a single clock cycle, and N is greater than 1.

22. The neural network chip of claim 21, wherein the second accumulation circuitry in the second routing circuitry comprises N accumulator circuits.

23. The neural network chip of claim 18, wherein:
the neural network chip further comprises a bias circuit;
the first routing circuitry of the first tile is configured to transmit a second control signal to the bias circuit when the first data has been generated; and
the bias circuit is configured to transmit one or more bias elements to the first routing circuitry of the first tile when the second control signal is received.

24. The neural network chip of claim 1, wherein the first tile is configured to perform further multiply-accumulate operations while the first data is being transmitted to the second tile

25. An ear-worn device comprising the neural network chip of claim 1.

26. The ear-worn device of claim 25, wherein the ear-worn device is a hearing aid, a cochlear implant, or an earphone.
